(19) United States
(12) Patent Application Publication
(10) Pub. No.: US 2007/0223763 A1
(43) Pub. Date: Sep. 27, 2007

(54) Digital Loudspeaker

(75) Inventors: Irving Alexander Bienek, Cambridge (GB); James Davies, Cambridge (GB); Mark George Easton, Cambridge (GB); Angus Gavin Goudie, Cambridge (GB); Anthony Hooley, Cambridge (GB); Shinichi Makino, Cambridge (GB); Andrew Morley, Cambridge (GB); David Charles William Richards, Cambridge (GB); Mark Richard Shepherd, Herts (GB); Paul Raymond Windle, Essex (GB)

Correspondence Address: NIXON & VANDERHYE, PC, 901 NORTH GLEBE ROAD, 11TH FLOOR, ARLINGTON, VA, 22203, US

(73) Assignee: 1... LIMITED, Cambridge (GB)

(21) Appl. No.: 10/571,689

(22) PCT Filed: Sep. 16, 2004
(86) PCT No.: PCT/GB04/03980

§ 371 Date: Dec. 27, 2006

(30) Foreign Application Priority Data
Sep. 16, 2003 (GB) 0321676.9

(51) Int. Cl. H04R 5/02

(52) U.S. Cl. 381/337

(57) ABSTRACT

A loudspeaker comprises a region devoid of electroacoustic transducers and at least two groups of electroacoustic transducers at the periphery of the region. Each of the groups is configured to produce a different sound field representative of an audio signal and each of the groups comprise a different set of transducers. This allows a more compact loudspeaker to be provided because the transducers can be located around the periphery of a visual display screen. Sound quality is not compromised because groups of transducers forming a subset of the totality of transducers are used for each sound signal, thereby avoiding alias beams.

### FIELD OF THE INVENTION

The invention relates to loudspeakers suitable for home entertainment or professional sound reproduction applications. More specifically, it relates to a device including an array of electro-acoustic transducers capable of receiving a multi-channel audio input signal and producing independently steerable and focusable beams of audible sound.

### BACKGROUND OF THE INVENTION

Digital phased-array loudspeakers (or more correctly, Digital Delay Array Loudspeakers), hereinafter DDALs, are known in the art (for example, international Applications published as WO01/23104 and WO02/078388.) These patent applications teach how to use DDALs to produce full surround sound, in for example its common 5.1 channel form, using just one DDAL, and in this manner replacing a multitude of separate loudspeakers, dispersed around a listening room or space, and also dispensing with all the necessary connecting wires required for conventional multiple-discrete-loudspeaker surround sound systems.

The key to successful operation elaborated in these documents is twofold: first, producing multiple, simultaneous, independently steered, independently delayed beams of sound each containing independent acoustic signals, from one and the same DDAL; and second, using features of the listening space including walls, floors ceilings and possibly furniture and even deliberately positioned reflectors, to guide these multiple separate beams of independent sound towards the listening area from several different directions, so that the listener hears sound coming from a host of directions (because it really is), and thus experiences the full effects of surround sound.

The DDALs known in the art are area extensive, that is they fill a region of 2-D space. It is described in the prior art to cover a DDAL transducer array with an acoustically transparent optically reflective or diffusive screen, for the presentation of front-projected images onto the surface of the DDAL, thus combining (surround) sound generation and visual display into one compact unit. However, it has not been previously possible to so compactly combine DDALs with other conventional visual displays (i.e. non-front-projection) because the presence of the DDAL would obscure or otherwise limit the visibility of the visual display. In practice, DDALs have been used next to (e.g. above, below or beside), visual display screens resulting in bigger and less practical systems than is desirable. Additionally, for the all-important speech centre channel, there is a significant offset between the acoustic centre of the DDAL and the visual centre of the display, and this can be disconcerting to listeners, especially when close to the screen.

One aim of the present invention is to provide an audio-visual system capable of surround sound that is more compact, while maintaining good sound quality.

### SUMMARY OF THE INVENTION

In the present invention, a practical effect is achieved somewhat similar to that produced by the abovementioned DDALs, using in some cases simpler physical hardware, which is therefore capable of manufacture at lower cost and with less complexity. Furthermore, there are practical advantages in the designs and methods of the present invention, which make the integration of a practical and useful DDAL into and around a conventional video display device possible, eliminating the requirement for an additional piece of equipment, adjacent to or separate from the video display itself.

A problem arises when a set of transducers in a non-contiguous group is used to direct sound beams in a direction spanning the non-contiguous part (i.e. the “hole” separating distant transducers of the same group).

Experiments and analysis of DDALs with substantial “holes” in them show that such holes in the array produce “alias” beam. These alias beams have similar amplitude to the intended beam and radiate in unintended directions. This problem of alias beams arises when the hole, that is, the area within the array devoid of transducers, has one or both dimensions (horizontal or vertical) greater than half a wavelength of sound at a given frequency. For example, when one of the dimensions of the hole is of the order of half a meter (a typical dimension for a television screen for example), the frequency above which alias beams occur is of the order of 1300 Hz, which is well within the speech band.

Due to the problem of alias beams, it has heretofore not been thought possible to provide adequate beam steering using a DDAL that is not contiguous and area extensive.

Thus it is one of the aims of the present invention to minimise or avoid production of unwanted alias beams despite the transducer array as a whole containing a very substantial hole or gap.

By partitioning the transducers into groups and using each group as a separate DDAL for a specific input signal (channel), such aliases can be avoided. One or more groups (for one or more respective channels) may comprise all the transducers of the array, but it is an important aspect of the invention that at least one group comprises transducers from part of the array only. Preferably, such a partial group comprises contiguous transducers only; that is, each transducer is adjacent to one or more other transducers in the group and there are no significant gaps in the group. More preferably, the group does not surround the ‘hole’, that is, it comprises transducers from one side of the hole but not transducers from the opposite side of the hole.

An example of transducer grouping to avoid alias beams is as follows. A digital loudspeaker for reproduction of 5-channel surround sound comprises transducers arranged along the left edge, the bottom edge and the right edge of a display screen. The centre channel is reproduced by all the transducers. The right channel is reproduced by a partial group comprising the transducers to the right of the screen, while the left channel is reproduced by the partial group comprising the transducers to the left of the screen. The Rear Right and Rear Left channels are reproduced by groups comprising transducers at the bottom edge of the screen and optionally some or all of the transducers on the respective right and left sides. Further details of this and other arrangements are given below.

The present invention provides a loudspeaker comprising:
a region devoid of electroacoustic transducers;
a first group of electroacoustic transducers at the periphery of said region, said first group of transducers being configured to produce a first sound field representative of a first audio signal;
a second, different, group of electroacoustic transducers at the periphery of said closed region, said second group of transducers being configured to produce a second, different, sound field representative of a second audio signal.

Preferably, the groups of transducers are each contiguous. This, however, depends on the beam steering ability that is required and groups can be non-contiguous in a particular direction if beam steering ability in that direction is not necessary. For example, if beam steering in a left-right direction only is required, the group need only be contiguous in the left-right direction and can be non-contiguous in the up-down direction.

One of the groups may comprise all of the transducers in the array. Some of these transducers are then shared with other groups and there is no limitation on groups overlapping or being otherwise related to one another. The first and second group of transducers must, however, be different, that is to say one of the groups must contain at least one transducer that is not contained in the other group.

In a preferred aspect of the invention the region is a 2D region and the set of transducers are disposed about the region so as to partially fill an extent of more than 2/7th (˜0.29) of the perimeter of the region.

In a preferred aspect of the invention, the region is nominally planar of rectangular shape, and in other preferred aspects region shapes such as planar square, circular or elliptical, and non-planar polygons, spheres and ellipsoids are used.

In another preferred aspect of the invention, a nominally rectangular visual display screen [VDS] (e.g. a CRT, plasma panel display, LCD display, or one of the more recent display developments such as LEP, field emission display, or even static or quasi-static visual display devices or posters as used e.g. in advertising or other information display devices) forms the region about which the set of electroacoustic transducers are located, close to or adjacent to its outer edge, so as not to overlap the visually-important portion of the visual display device, but possibly overlapping its other (non-visually important) structure. The array of electroacoustic transducers is used wholly, or partially, in one or more discrete groups, each group preferably forming a DDAL, so as to produce in total one or more different and simultaneous sound fields, each representative of different audio programmes related to the visual presentation on the VDS, or instead a totally unrelated set of audio programme material such as for example the soundtrack on a CD or DVD music disk, or e.g. an advertising message, or sounds and sound effects for a video game. The invention is not limited to such an array surrounding a rectangular VDS, as other shapes of VDS (or displayable portion of VDS screen), such as e.g. circular or elliptical, can equally be accommodated within the invention.

In a preferred form of the invention, all or some of the set of electroacoustic transducers to the left of the centre of the region, e.g. a VDS screen, are used to form a DDAL to reproduce that part of the audio programme normally assigned to the left channel of a surround sound system (the L channel), whilst some or all of the set of electroacoustic transducers to the right of the centre of the region, e.g. a VDS screen, are used to form a DDAL to reproduce that part of the audio programme normally assigned to the right channel of a surround sound system (the R channel). Some or all of the whole set of electroacoustic transducers are used to form a DDAL to reproduce that part of the audio programme normally assigned to the centre channel of a surround sound system (the C channel). Some or all of the whole set of electroacoustic transducers are used to form a DDAL to reproduce that part of the audio programme normally assigned to the left rear (effects) channel of a surround sound system (the LR channel), and some or all of the whole set of electroacoustic transducers are used to form a DDAL to reproduce that part of the audio programme normally assigned to the right rear (effects) channel of a surround sound system (the RR channel). Additional audio channels (such as exist in for example DTS 7.1channel sound, can be similarly assigned to a DDAL composed of some or all of the whole set of transducers and the invention is not limited to 2, 3, 4, 5, 6, 7, or other numbers of discrete channels of sound.

In another preferred form of the present invention, some of these DDALs will be composed of an identical group of transducers as other DDALs in the array. For example, in another variant, the whole set of transducers are used to form a DDAL used to reproduce both the LR, the RR and the C channels. In this case one, two or three separate sound beams may be formed by this particular DDAL group within the array of DDAL transducers comprising the whole device.

In the simplest case just one beam reproduces all three of these channels. In an enhanced version of this form, this particular DDAL uses one sound beam directed directly at the listening position to project the C channel audio, and a second sound beam directed over the heads of the listeners (in the listening position) which then bounces off for example the ceiling and rear wall(s) of the listening room, to return towards the listening position from behind the listeners, this beam carrying a mixture of the LR and RR audio channels. In a third preferred form of this aspect of the invention, this DDAL directs the C channel beam as before, and two additional sound beams (instead of one additional) are used to direct the LR channel over and to the left of the listening position, and the RR channel over and to the right of the listening position, so that the rear channels are heard by the listeners to come not just from behind the listeners, but also from behind and to the left and right respectively.

In another aspect of the invention the region-surrounding DDALs previously described are augmented by one or more woofers (loudspeakers especially good at the reproduction of low frequencies, say from 300 Hz downwards, or from 200 Hz downwards, to at least 100 Hz, or to 50 Hz or even to 20 Hz). These woofers may be disposed about the region (e.g. a VDS) in any way compatible with the desired disposition of the transducers forming the DDALs, and not obscuring the region, in which cases they are used to reproduce the low frequencies directly without any attempt at forming these low frequencies into steered sound beams, or alternatively, the woofers may instead be part of one or more of the totality of DDALs and incorporated into the digital delay sound beam-forming array(s) so as to extend downwards the frequency at which the apparatus is able to usefully direct and steer sound beams. In either case the low frequency sound signals applied to the woofers may be delayed to ensure that the sounds emitted by them reach the listeners in time synchronisation with the higher frequencies from the rest of the DDAL(s) which travel by potentially much longer acoustic paths involving one or more bounces.

In one variant of the invention, the transducers are disposed right around the periphery of the region, with substantially uniform a real density (but not necessarily with uniform or constant spacing) and substantially uniformly spaced from the edge of the region, and this is particularly preferred when the region is rectangular, and more particularly preferred when the region is a rectangular VDS. A first simplified version of this variant eliminates some or all of the transducers positioned along the top, or bottom, or both, of the region, while a second simplified version of these preferred aspects eliminates some or all of the transducers positioned along the left side, or right side, or both, of the region, again especially preferred when the region is a VDS. One preferred variant of these just-described forms has transducers of uniform size uniformly spaced around the region.

In another preferred aspect of the invention, any or all of the previously described DDAL forms when disposed around a VDS, may be augmented by one or more optically transparent loudspeaker forms covering some or all of the visually important areas of the VDS (i.e. exactly those areas of the VDS not otherwise populated by DDAL transducers), and these transparent loudspeaker forms may be either incorporated into one or more of the DDAL groups or instead used separately and independently, for example to reproduce low frequencies, or perhaps to reproduce centre-channel information in a surround sound system built around a VDS.

In all of the above aspects of the invention it is intended that the transducers forming the DDAL groups surrounding or partially surrounding the region devoid of transducers may be of any size at all consistent with the area aspects already defined, and consistent with the acoustic requirements of the beam forming DDAL as described in the prior art. Where the transducers are relatively small compared to the greatest linear dimension of the whole array of transducers, they may form concentric (not necessarily circular) rings around the region, or be otherwise disposed around the region so that some transducers are naturally closer to the edge of the region than others, and so that others are closer to other transducers than they are to the edge of the region. That is to say, there is no restriction to the transducers being in only one line (straight or curved) around the region, nor that they should necessarily as a group, enclose the region.

In another preferred aspect of the invention, a subset of the transducers forming one of the DDAL groups are arranged in multiple substantially parallel rows with substantially similar spacing within each and every row, although the row-to-row spacing may differ from this intra-row spacing, and where the substantially parallel rows are substantially parallel to at least one significant portion of an edge of the region (e.g. where the region is substantially rectangular, the transducer rows may be parallel to at least one edge of the region). In such a case, and where it is not necessary to be able to electronically steer this DDAL beam in a plane normal to the parallel rows of transducers, the complexity of the DDAL drive and control electronics may be simplified by driving adjacent transducers in adjacent parallel rows (i.e. transducers in the same ‘column’) with signals of the same identical delay (rather than different delays), whilst retaining the ability to vary the signal delay from transducer to transducer within each row. Such an arrangement provides one-dimensional (1D) beam forming and electronic steering in a plane parallel to the parallel rows of transducers. If the separation between the outer edges of transducers in the first and last rows is substantial, and specifically comparable to or greater than a wavelength of sound in air at a frequency of interest for directing the sound, then the parallel row array will be substantially directional if not electronically steerable in the plane orthogonal to the parallel rows of transducers, and in this case it may be advantageous to tilt the plane of the rows of transducers relative to the region so as to orientate the directional beam in a preferred direction relative to the region. A similar effect may be achieved by using just one (or a few) row(s) of transducers with high aspect ratio (e.g. elliptical transducers) with their short axis parallel to the row direction.

In a preferred embodiment of the invention, a digital loudspeaker comprises an array of electoacoustic transducers, used in two or more non-identical groups, each group forming a DDAL, so as to produce two or more different and simultaneous sound fields, each representative of different audio signals.

In a further embodiment of the invention, a closed region of a planar or non-planar surface has a set of more than four, preferably more than 8, electroacoustic transducers positioned close to or adjacent to its outer edge, so as not to overlap the region and not to substantially overlap each other, the surface area of the region being substantially greater than the acoustic-radiating surface area of any of the transducers and in a preferred aspect the region-surface-area being greater than half of the total acoustic-radiating surface area of all of the transducers, wherein the set of electroacoustic transducers is used wholly, or partially, in one or more discrete groups, each group forming a DDAL, so as to produce in total two or more different and simultaneous sound fields, each representative of different audio signals.

As already mentioned, one application for the invention is to provide surround sound with less cabling and no need for satellite speakers. Another application is to output two beams of audio signals, each signal representing a completely different programme, for example a television programme audio signal. If the beams are steered in different directions two users standing or sitting in different positions can receive different audio programmes. This can be combined with a split screen VDS to allow two users to watch different TV channels, with full sound, without disturbing each other.

This can be extended to 3, 4 or more separate programmes being shown simultaneously on the same device, the audio channel for each programme being directed towards a user in a different direction, with an optional corresponding video channel being shown on the VDS in split-screen mode.

### BRIEF DESCRIPTION OF THE DRAWINGS

The present invention will now be described, by way of example only, with reference to the accompanying drawings, in which:—

FIG. 1 is a schematic representation of an embodiment of the invention;

FIG. 2 represents a further embodiment of the invention in which the transducers surround a video display screen (VDS);

FIG. 3 represents a further embodiment of the invention in which different subsets of transducers reproduce different audio channels;

FIGS. 4A and 4B represent further embodiments in which the transducers are disposed along two opposing edges of a VDS;

FIG. 5A and 5B represent further embodiments including large-area transducers;

FIG. 6A and 6B represent a further embodiment in which the transducers are grouped; and

FIG. 7 represents the further embodiment of the invention and shows three groups of transducers, each group potentially forming a separate DDAL around the periphery of a region devoid of transducers.

### DETAILED DESCRIPTION

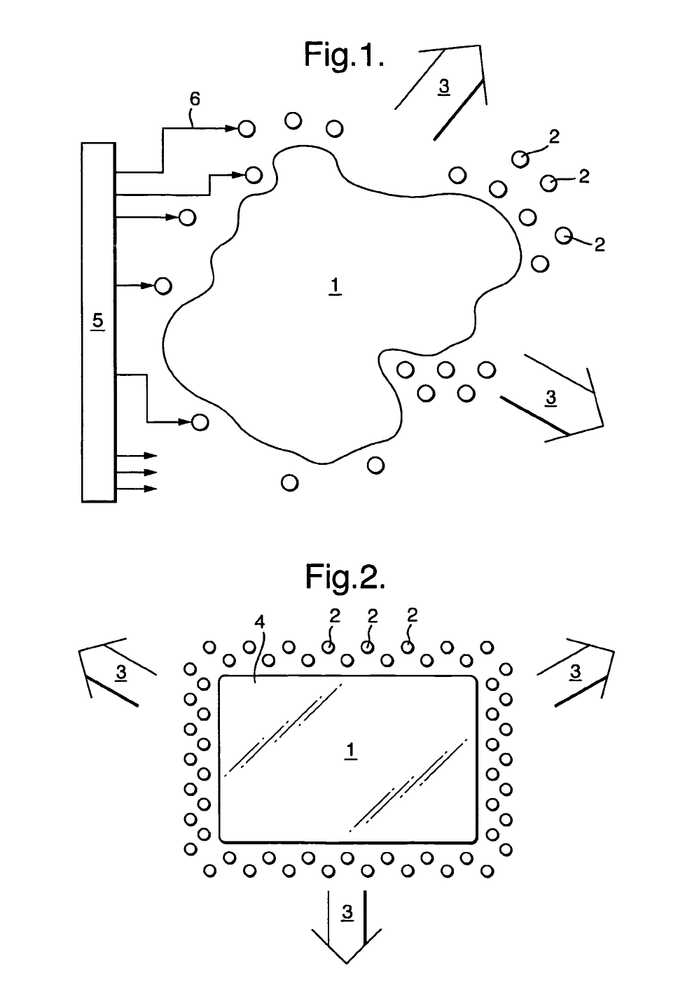

FIG. 1 is a schematic representation of an example of a Digital Loudspeaker of the invention. A closed planar region 1 has at its periphery a set of transducers, represented by the closed circles in FIG. 1, three of which are labelled 2. Each transducer 2 is very substantially smaller in area than the region 1. The set of transducers 2 forms a Digital Delay Array Loudspeaker, DDAL, which may be operated in one or more discrete transducer groups, each group preferably forming a DDAL so as to produce one or more different and simultaneous sound fields, represented schematically by the broad arrows 3. The transducers 2 are controlled by DDAL control and drive electronics, shown schematically as enclosed in the box 5. Each transducer 2 is connected to the control electronics, as indicated by arrows of the type 6 (for clarity, not all the connections 6 are shown).

FIG. 2 is a schematic representation of a further embodiment of the invention. The region 1 about which the transducers 2 are disposed is nominally rectangular and comprises a visual display screen (VDS) 4 such as a television screen. Preferably, the VDS 4 fills the region 1. The transducers are controlled as in FIG. 1 to produce one or more different and simultaneous sound fields 3 (three are shown). The transducers 2 are arranged close to the periphery of the screen 4 and are closely and regularly spaced. This arrangement forms a compact and effective surround sound system for a television.

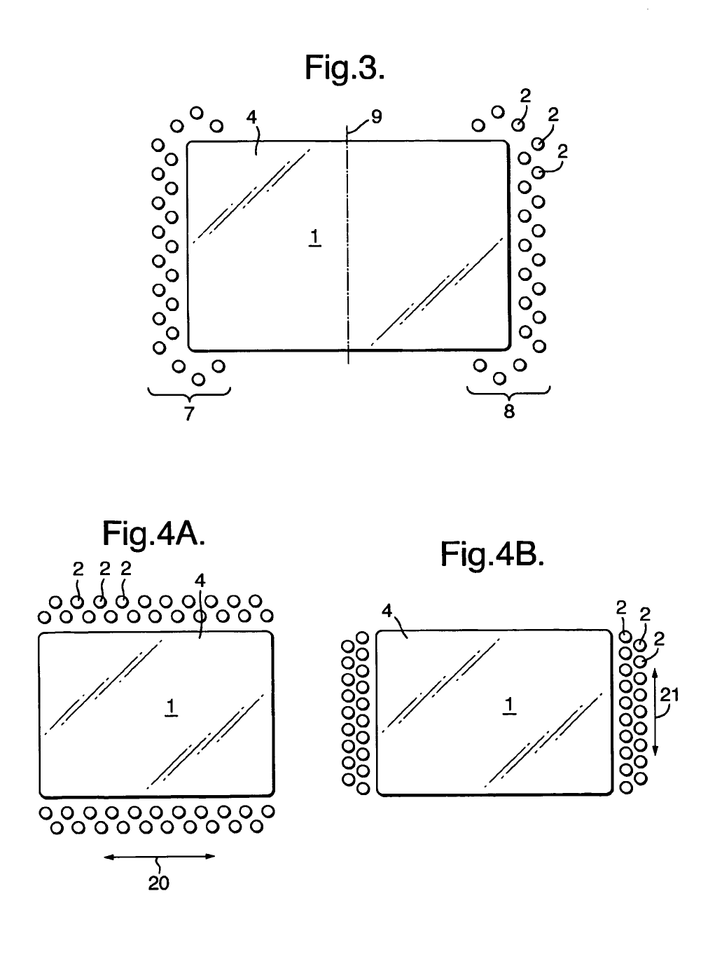

FIG. 3 shows a schematic representation of a variant of the embodiment of FIG. 2 in which the transducers 2 are grouped in two sets 7 and 8 disposed to either side of a nominal centre line (dashed line) 9 of the region 1 which is filled with a VDS 4. In this variant, the set of transducers 7 on the left side of the screen may be controlled to produce the left channel of an audio signal, while the set 8 on the right produces the right channel, as in conventional stereo. These sets 7 and 8 optionally need not be operated in DDAL mode to produce the stereo left and right channels, as their position provides some stereo effect. This reduces the complexity of the electronics. Other audio channels, such as centre and rear channels, are produced by the same transducers 2, perhaps operating in DDAL mode as described above.

FIGS. 4A and 4B show schematic representations of further embodiments of the invention in which the transducer arrangement is further simplified. The transducers 2 are disposed along two edges of the rectangular region 1 in which there is a VDS 4. In FIG. 4A, the transducers are disposed along the top and bottom edges only, while in FIG. 4B the transducers are disposed at the sides only. These configurations are more compact and simpler (and therefore less costly to manufacture) than the embodiments with transducers at all four edges of a screen. The sound beams produced when they are operated in DDAL mode are fully steerable in the directions marked by the double headed arrows 20 and 21, and retain some lesser steerability in the orthogonal direction (up and down in FIG. 4A and left and right in FIG. 4B). Further variants (not shown) include transducers disposed along one edge only or along three edges of a screen, L-shaped arrangements of transducers around one or more of the corners of the screen, and single rows of transducers arranged along any or all edges.

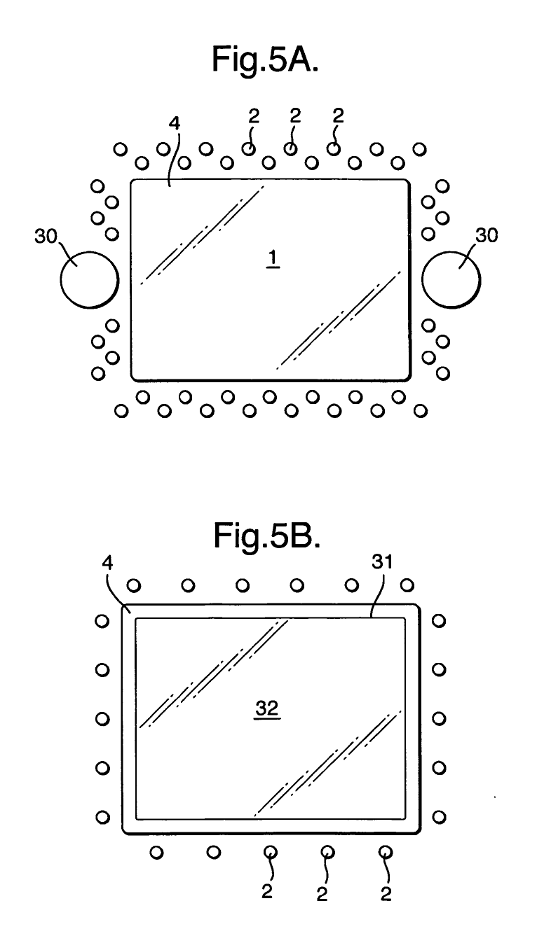

In FIGS. 5A and 5B, further embodiments of the invention incorporating one or more larger transducers are shown. As before, the array of smaller transducers 2 disposed around a screen 4 produces one or more directed sound beams. FIG. 5A shows in addition two larger transducers (woofers) 30 which, partly by virtue of their larger radiating area and partly by virtue of their construction, more effectively reproduce low frequency sound. In FIG. 5B, the larger-area transducer 31 has a transparent sound-radiating diaphragm 32 which is disposed in the region 1 overlaying the screen 4. The transparent diaphragm 32 is driven from one or more of its edges (mechanism not shown) or possibly by pressurised fluid from behind.

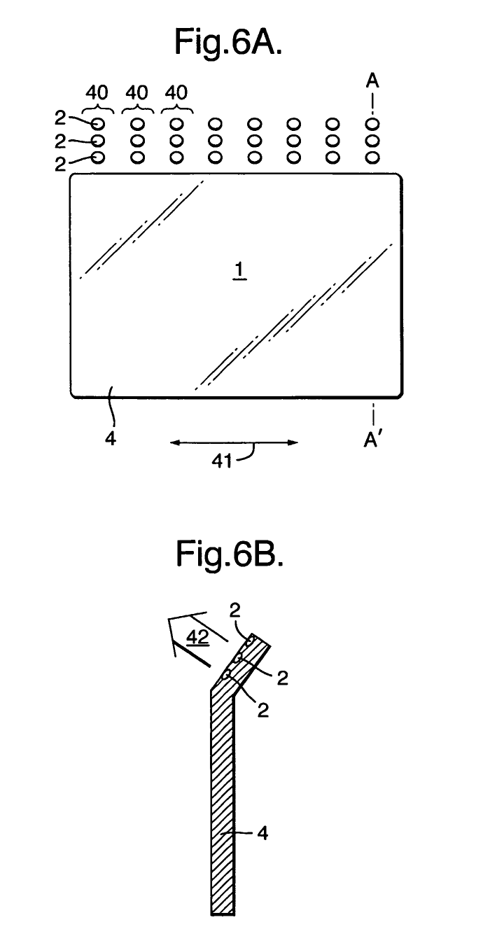

FIG. 6A and 6B show a further variant of the invention in which the transducers are grouped. As before, transducers 2 are disposed along an edge of a region 1 housing a display screen 4. In this case, the transducers 2 are arranged into columns 40, each column 40 comprising three transducers 2. The transducers within a single column 40 are driven with identical delays, while transducers in different columns are driven with different delays. This reduces the complexity of the DDAL drive and control electronics. In this mode, the sound beams produced are steerable in the direction of the double headed arrow 41 but not in the orthogonal direction (up and down). However, some measure of vertical steering is provided by angling the transducer array upwards, as shown in the cross-section of FIG. 6B, taken along the dashed line A-A′ of FIG. 6A. The sound is directed upwards to some extent in the direction of the broad arrow 42.

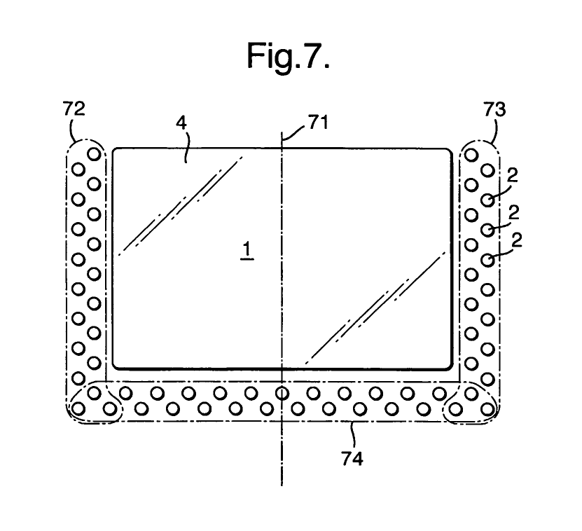

FIG. 7 illustrates the best known mode of a practical compact Digital Loudspeaker arranged for reproduction of surround sound. Five beams of sound reproduce the respective five channels, Center (C), Left (L), Right (R), Rear Left (RL) and Rear Right (R). As before, the transducers 2 are arranged around a region 1 which contains a display screen 4. In this case, the transducers 2 are arranged two rows deep along the left, bottom and right periphery of the region 1. The Centre channel is reproduced by all transducers of the array. Since the array is symmetrical about the vertical line 71, speech will be perceived by the listener as emanating correctly from the centre of the screen. The left channel is reproduced by the partial group 72 of transducers to the left of the screen. The right channel is similarly reproduced by the partial group 73 to the right of the screen. The left and right channels may be steered or simply output with no delays, the stereo effect being achieved by the relative positioning of the groups. Each group comprises contiguous transducers only such that alias beams are avoided. Similarly, the Rear Right and Rear Left channels are reproduced by a further partial group 74 comprising the transducers along the bottom of the screen. This group 74 has considerable horizontal extent, allowing accurate steering of the beam to the rear corners of the room for reflection back to the listening position. Again alias beams are avoided as the transducers are contiguous.

It will be noted that groups 72 and 73 each overlap somewhat with group 74. In this embodiment, three transducers of group 74 are also used in group 73 and three different transducers of group 74 are also used in group 72. There is no restriction on the amount of overlapping that can be allowed between groups.

The loudspeaker of the present invention is preferably provided as an integral unit having a casing in which each of the transducers of the array are disposed. When the region devoid of transducers comprises a screen, the screen is preferably integrated with the speaker casing so as to provide a single consumer unit.

claims

1

-

27

. (Canceled)

28. A loudspeaker comprising:
a region devoid of electroacoustic transducers;
a first group of electroacoustic transducers at the periphery of said region, said first group of transducers being configured to produce a first sound field representative of a first audio signal;
a second, different, group of electroacoustic transducers at the periphery of said closed region, said second group of transducers being configured to produce a second, different, sound field representative of a second audio signal;
wherein one of said first sound field and said second sound field is a directable sound beam.

29. A loudspeaker according to claim 28, wherein said first group of transducers is located at a part of the periphery of said region substantially opposite to the part of the periphery of the region at which said second group of transducers is located.

30. A loudspeaker according to claim 29, wherein said first group of transducers is located at the left side periphery of said region and said second group of transducers is located at the right side periphery of said region.

31. A loudspeaker according to claim 30, further comprising:
a third group of electroacoustic transducers at the periphery of said region, said third group of transducers being configured to produce a third sound field representative of a third audio signal.

32. A loudspeaker according to claim 31, wherein said third group of transducers is located at the bottom periphery of said region.

33. A loudspeaker according to claim 31, wherein said first group of transducers is adapted to output an audio signal of a left-hand surround sound channel, said second group of transducers is adapted to output an audio signal of a right-hand surround sound channel and said third group of transducers is adapted to output an audio signal of a rear-left and a rear-right surround sound channel.

34. A loudspeaker according to claim 33, wherein said first, second and third groups of transducers are configured to together output an audio signal of a centre surround sound channel.

35. A loudspeaker according to claim 31, wherein said third group of transducers shares at least one transducer with said first group of transducers and shares at least one, different, transducer with said second group of transducers.

36. A loudspeaker according to claim 35, wherein said at least one shared transducer is located at the corner of the periphery of the region.

37. A loudspeaker according to claim 28, further comprising additional groups of electroacoustic transducers at the periphery of said region, each said group of transducers being configured to produce an additional sound field representative of an additional audio signal.

38. A loudspeaker according to claim 37, wherein there are three additional groups of electroacoustic transducers, there being five groups of electroacoustic transducers in total, each group of transducers being configured to produce a sound field representative of a different surround sound audio channel.

39. A loudspeaker according to claim 28, wherein said region devoid of transducers is rectangular, the longer side of the rectangle being horizontal.

40. A loudspeaker according to claim 39, wherein said region devoid of transducers comprises a visual display screen.

41. A loudspeaker according to claim 28, wherein transducers are located around at least two sevenths of the periphery of the region devoid of transducers.

42. A loudspeaker according to claims 28, further comprising an optically transparent transducer covering at least part of said region devoid of transducers.

43. A loudspeaker according to claim 28, wherein said first group of electroacoustic transducers extends in two dimensions so as to provide, in use, the ability for said first group to direct a first sound beam in a range of directions spanning two dimensions.

44. A loudspeaker according to claim 28, wherein said first and second groups of transducers are each contiguous.

45. A loudspeaker according to claim 28, wherein said first sound field is a sound beam directable using said first group of transducers.

46. A loudspeaker according to claim 45, wherein said second sound field is a sound beam directable using said second group of transducers.

47. A loudspeaker according to claim 46, wherein said sound beams are directable by introducing selected digital delays to the audio signal driving each transducer of a group.

48. A loudspeaker according to claim 28, wherein said first audio signal is of a first program and said second audio signal is of a second, different, program.

49. A loudspeaker according to claim 48, further comprising additional groups of electroacoustic transducers at the periphery of said region, each said group of transducers being configured to produce an additional sound field representative of an additional audio signal, said additional audio signals each being of different programs.

50. A loudspeaker according to claim 28, wherein said first and second groups of transducers overlap, such that at least one transducer is shared by said first and second groups.

51. A loudspeaker according to claim 28, wherein there are a plurality of groups of transducers, each group configured to produce a sound field representative of a different audio signal, wherein several of the groups of transducers overlap.

52. A digital loudspeaker comprising an array of electroacoustic transducers, used in two or more non-identical groups, each group forming a DDAL, so as to produce two or more different and simultaneous sound fields, each representative of different audio signals.

53. A loudspeaker comprising a closed region devoid of electroacoustic transducers, said closed region having a set of more than four electroacoustic transducers positioned close to or adjacent to its outer edge, so as to not overlap the closed region and not to substantially overlap each other, the surface area of the closed region being substantially greater than the acoustic-radiating surface area of any of the transducers;
wherein the set of electroacoustic transducers are arranged to produce a directable sound beam.

54. A loudspeaker according to claim 53, wherein the surface area of the closed region is greater than half of the total acoustic-radiating surface area of all of the transducers in the loudspeaker.

55. A television or computer monitor having a loudspeaker according to claim 28 integrated therewith, the television or monitor screen being positioned in the region devoid of electroacoustic transducers.

56. A television or computer monitor having a loudspeaker according to claim 52 integrated therewith, the television or monitor screen being positioned in the region devoid of electroacoustic transducers.

57. A television or computer monitor having a loudspeaker according to claim 53 integrated therewith, the television or monitor screen being positioned in the region devoid of electroacoustic transducers.
